(19) United States
(12) Patent Application Publication
(10) Pub. No.: US 2005/0079852 A1
(43) Pub. Date: Apr. 14, 2005

(54) Modular entertainment system

(76) Inventor: Thomas Tseng, La Habra Heights, CA (US)

Correspondence Address: JOE NIEH, 18760 E. AMAR ROAD #204, WALNUT, CA, 91789, US

(21) Appl. No.: 10/682,580

(22) Filed: Oct. 9, 2003

(51) Int. Cl. H04Q 7/20

(52) U.S. Cl. 455/334

(57) ABSTRACT

A modular entertainment system that is mounted overhead on the roof inside an automobile comprising three main interchangeable components including a DVD player, a multi-function dome light, and a flip-down display. All three components are interchangeable to allow full customization of the modular entertainment system.

### BACKGROUND

1. Field of Invention

The present invention relates generally to an entertainment system. More specifically the present invention is a modular entertainment system with interchangeable components that can be mounted overhead in a vehicle.

2. Description of Related Art

Modern vehicles are not simply a means of transportation. Automobiles not only transport people from one place to another but also provide entertainment to the occupants during transit. The entertainment source may be in the form of a simple AM/FM radio, an AM/FM radio with cassette player, an AM/FM radio with CD player, a CD player, a DVD player, a video game console, a television, a video cassette player, or any other audio/video source.

Generally the entertainment source is installed inside the dashboard within the center console and within easy reach of the driver and front passenger of an automobile. The bulkier units such as a CD changer and a video cassette player may be installed inside the trunk of an automobile with the controls installed on the center console of the dash board. Recently, many automobile manufacturers offer the option of an overhead entertainment system installed on the inside rooftop of an automobile with a flip-down liquid crystal display to allow viewing of television programs and movies on DVD. However, once the entertainment system in installed, the components cannot be changed as the user's need changes. For example, as new and better DVD players emerge, the user cannot upgrade their entertainment system easily. The entire entertainment system must be removed and replaced with a new entertainment system. Also, if the user desires to use a larger or better display, the entire entertainment system must also be removed and replaced. These types of entertainment system is very expensive to upgrade and virtually impossible to customize to any particular user's needs.

### SUMMARY OF THE INVENTION

The present invention is a modular entertainment system that is mounted overhead on the roof inside an automobile. The modular entertainment system comprises of three main interchangeable components. The modular entertainment system comprises of a DVD player, a multi-function dome light, and a flip-down display. All three components are interchangeable to allow full customization of the modular entertainment system.

### BRIEF DESCRIPTION OF THE DRAWINGS

FIG. 1 shows the three main components in the preferred embodiment of the modular entertainment system.

FIG. 2 shows the preferred embodiment of the modular entertainment system with the three main components assembled.

FIG. 3 shows another embodiment of the modular entertainment system with two components.

FIG. 4 shows a perspective view of the preferred embodiment of the modular entertainment system.

FIG. 5 shows an embodiment of the multi-function dome light.

FIG. 6 shows two embodiments of the flip-down display.

FIG. 7 shows the preferred embodiment of the modular entertainment system installed overhead on the roof inside a vehicle.

### DETAILED DESCRIPTION OF THE PREFERRED EMBODIMENT

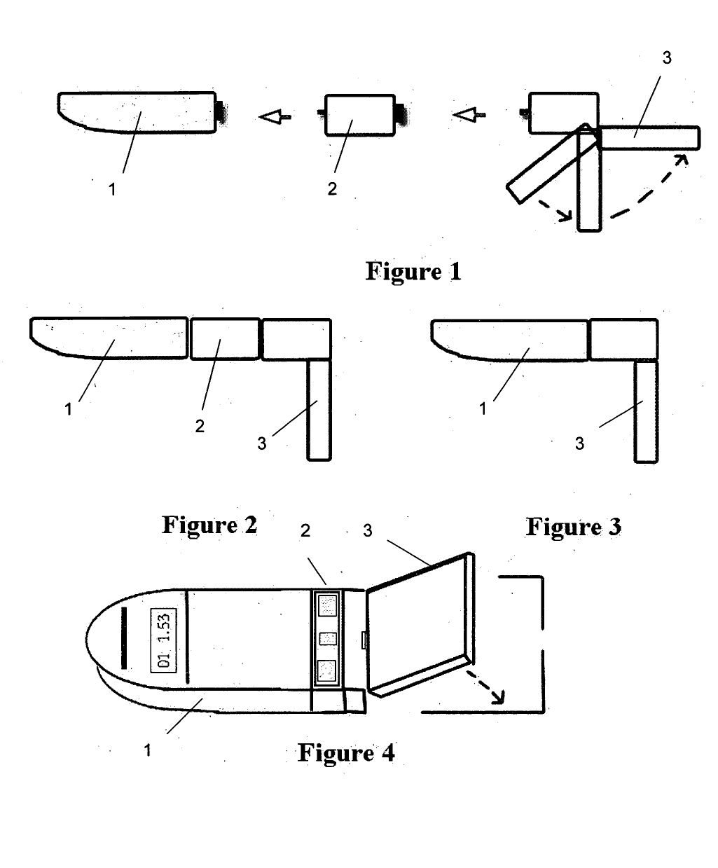

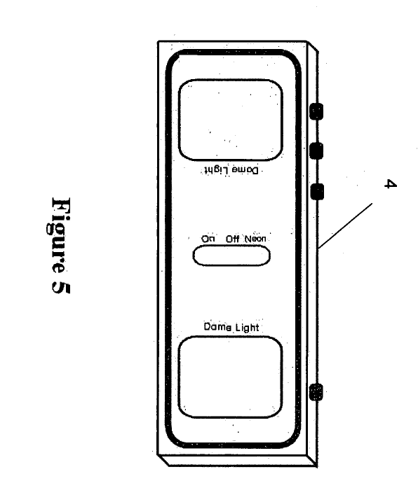

FIGS. 1, 2, and 4 show the three main components in the preferred embodiment of the modular entertainment system. In the preferred embodiment, the modular entertainment system comprises of an interchangeable DVD player 1, an interchangeable multi-function dome light 2, and an interchangeable flip-down display 3. The standard dome light in an automobile is removed and replaced with the multi-function dome light 2. The multi-function dome light 2 has connections at both ends to allow the connection of a DVD player 1 on one end and a flip-down display 3 on the other end. All three components are interchangeable to allow customization of the modular entertainment system.

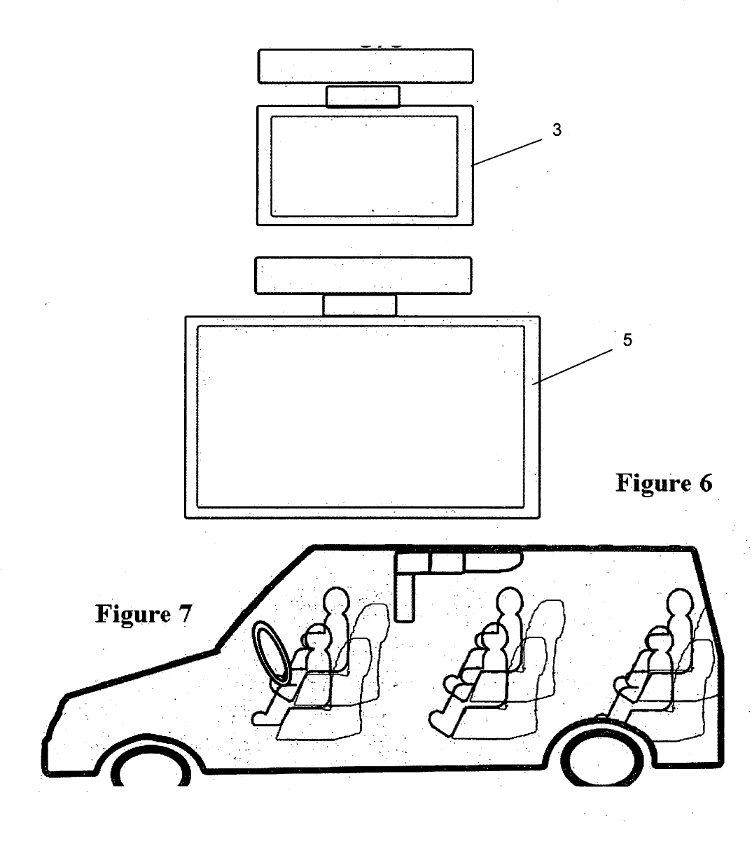

The DVD player 1 may be simply unplugged from the multi-function dome light 2 and replaced with another DVD player. The flip-down display 3 may also be unplugged from the multi-function dome light 2 and replaced with another flip-down display. For example, if the first flip-down display 3 is a small five-inch display and the user desires to change to a larger display, the small five-inch display 3 may be unplugged from the multi-function dome light 2 and replaced with a larger display 5 such as a twenty-one inch display as shown in FIG. 6. The multi-function dome light 2 may also be interchanged with another multi-function dome light 4 that has a built-in neon light as shown in FIG. 5 that may be turned on and off as desired and may also be synchronized to flash with the rhythm of the music in the vehicle. The multi-function dome light 2 may also be omitted from the modular entertainment system entirely as shown in FIG. 3 and the DVD player 1 may simply plug into the flip-down display 3 to form a compact modular entertainment system.

As shown in FIG. 7, in the preferred embodiment the modular entertainment system with the three components is mounted overhead inside the vehicle replacing the original dome light to allow rear passengers in the vehicle to view-and enjoy the modular entertainment system. The modular entertainment system is easily customizable to meet the needs of the user. All three components in the modular entertainment system are interchangeable to allow upgrade and customization of the individual components to meet the needs of the user.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

1. A modular entertainment system comprising a multi-function dome light with two ends with a DVD player electrically connected to a first end of said multi-function dome light and a flip-down display electrically connected to a second end of said multi-function dome light wherein the modular entertainment system replaces and installs in place of an original dome light in a vehicle.

2. A modular entertainment system as in claim 1, wherein said DVD player is interchangeable with another DVD player.

3. A modular entertainment system as in claim 1, wherein said flip-down display is interchangeable with another flip-down display.

4. A modular entertainment system as in claim 2, wherein said flip-down display is interchangeable with another flip-down display.

5. A modular entertainment system as in claim 1, wherein said multi-function dome light has a built-in neon light.

6. A modular entertainment system as in claim 5, wherein said multi-function dome light-with the built-in neon light may be turned on and off as desired and is also synchronized to flash with the rhythm of the music in the vehicle.

7. A modular entertainment system as in claim 2, wherein said multi-function dome light has a built-in neon light.

8. A modular entertainment system as in claim 7, wherein said multi-function dome light with the built-in neon light may be turned on and off as desired and is also synchronized to flash with the rhythm of the music in the vehicle.

9. A modular entertainment system as in claim 3, wherein said multi-function dome light has a built-in neon light.

10. A modular entertainment system as in claim 9, wherein said multi-function dome light with the built-in neon light may be turned on and off as desired and is also synchronized to flash with the rhythm of the music in the vehicle.

11. A modular entertainment system as in claim 4, wherein said multi-function dome light has a built-in neon light.

12. A modular entertainment system as in claim 11, wherein said multi-function dome light with the built-in neon light may be turned on and off as desired and is also synchronized to flash with the rhythm of the music in the vehicle.

13. A modular entertainment system comprising a DVD player electrically connected to a flip-down display wherein the modular entertainment system replaces and installs in place of an original dome light in a vehicle.

14. A modular entertainment system as in claim 13, wherein said DVD player is interchangeable with another DVD player.

15. A modular entertainment system as in claim 13, wherein said flip-down display is interchangeable with another flip-down display.

16. A modular entertainment system as in claim 14, wherein said flip-down display is interchangeable with another flip-down display.
